(19) United States
(12) Patent Application Publication
(10) Pub. No.: US 2011/0238270 A1
(43) Pub. Date: Sep. 29, 2011

(54) METHOD FOR TENDING AN AGRICULTURAL ESTATE

(75) Inventor: Xavier David Beaulieu, Saint-Emilion (FR)

(73) Assignee: VITIROVER, Saint-Emilion (FR)

(21) Appl. No.: 13/129,499

(22) PCT Filed: Nov. 13, 2008
(86) PCT No.: PCT/FR08/52040

§ 371 Date: May 16, 2011

(30) Foreign Application Priority Data
Nov. 16, 2007 (FR) 0759102

(51) Int. Cl. G06F 19/00

(52) U.S. Cl. 701/50

(57) ABSTRACT

A process for tending an agricultural estate, in particular a vine-growing or arboricultural estate, includes: defining at least one limited working perimeter (10), and carrying out a tending operation within the limited working perimeter (10) with at least one working device that is autonomous and able to recognize the limits of the limited working perimeter (10), and allowing the autonomous working device to move randomly within the limited working perimeter (10).

This invention relates to a process that is designed to facilitate the tending of an agricultural estate, in particular a wine-growing or arboricultural estate.

The purpose of the invention is more particularly the tending of the grass ground cover that is located in the vines, i.e., between the rows of vines and between the bases that are very close to the stocks, as well as in the tree plantings such as the pine forests.

The grass ground cover of the vine can occupy every row or only some rows on a plot; it is a cultivation method, also called agriculture under plant cover, which is beneficial for the vine in several ways.

First of all, by forcing the vine to compete with the grass for its nourishment, in particular for water and nitrogen, the strength of the vine is limited, and it is prevented from growing too quickly with excess leaves and grapes.

Next, the grass makes it possible to limit the erosion of the soil and gullying during heavy storms, and it acts as a regulator of the quantity of water by retaining a certain moistness in the soil during dry weather or by facilitating the evaporation of water after big storms or floods.

The grass ground cover also provides more lift on the ground for the passage of tractors or other vehicles, whereby the roots of the grass make it possible to retain a structure in the soil.

Finally, this grass ground cover limits the use of insecticides because certain leaf-destroying mites of the vine prefer grass and therefore attack the vine less. The grass also balances the biotope by keeping predators of the vine close to those that attack them. This is therefore a factor that is very favorable to the integrated struggle.

In a general manner, the grass ground cover makes it possible to limit the use of pesticides in the protection of crops, which is in keeping with the new environmental regulations.

Also, vintners seek to avoid the use of weed killers, and several solutions are available to them for removing tall grasses.

There is destruction by gas-supplied radiant heating. However, this solution proves increasingly expensive, on the one hand, and not very ecological, on the other hand.

Next, two other existing solutions are the turning of the earth or mowing.

The turning of the earth is generally done by tractor-towed vehicles, whereby said vehicles have to penetrate the soil far enough to turn the earth that is packed down by the wheels of the tractor. This process requires powerful and heavy tractors, which therefore themselves deeply pack the soil.

However, with such vehicles, it is impossible to turn the strip of earth that is located under the stocks, called “cavaillon,” without running the risk of pulling up or damaging multiple vines. Combatting the grass by these mechanical means compels the vintner to make several consecutive passes depending on the season, whereby these operations are called “chaussage” [earthing], “déchaussage” [lifting], and “decavaillonnage.”

These operations are necessary, however, because they have as their object to force the vines, in particular the young vines, to put down their root system deeper and deeper into the ground so as to make them less sensitive to weather hazards, be it dry conditions or overly wet conditions.

The turning of the earth under the stocks, in particular for the decavaillonnage or to remove tall grasses therefrom, therefore requires at least two operations: a first pass with a propelled vehicle and a second pass with a manual tool such as a hoe for working between the bases, whereby this second operation may prove very long and tedious according to the size of the plot that is tended.

In the same way as the turning of the earth, the grass ground cover at the level of the cavaillons forces the roots of the vines to develop at a deeper point. With the mowing between the vine rows not posing particular problems and being able to be performed in the same manner as lawn-mowing, the vintners therefore have every advantage in selecting this tending method.

However, in the same way as for the turning of the earth, the mowing processes and devices of the prior art do not allow easy and economical manual labor under the vine stocks, between the vine bases, and the trellis posts.

Also, the purpose of this invention is to eliminate the drawbacks of the prior art by proposing a process and a device for tending an agricultural estate, in particular a wine-growing or arboricultural estate, allowing savings in labor and facilitating the tending of the earth under the vine stocks, between the vine bases and the trellis posts, as well as in the arboricultural plantings.

For this purpose, the invention has as its object a process for tending an agricultural estate, in particular a wine-growing or arboricultural estate, characterized in that it consists in defining at least one limited working perimeter, carrying out a tending operation within said limited working perimeter with at least one working device that is autonomous and able to recognize the limits of said limited working perimeter, and allowing the autonomous working device to move randomly within said limited working perimeter.

Other characteristics and advantages will emerge from the following description of the invention, a description that is provided only by way of example relative to the accompanying drawings, in which:

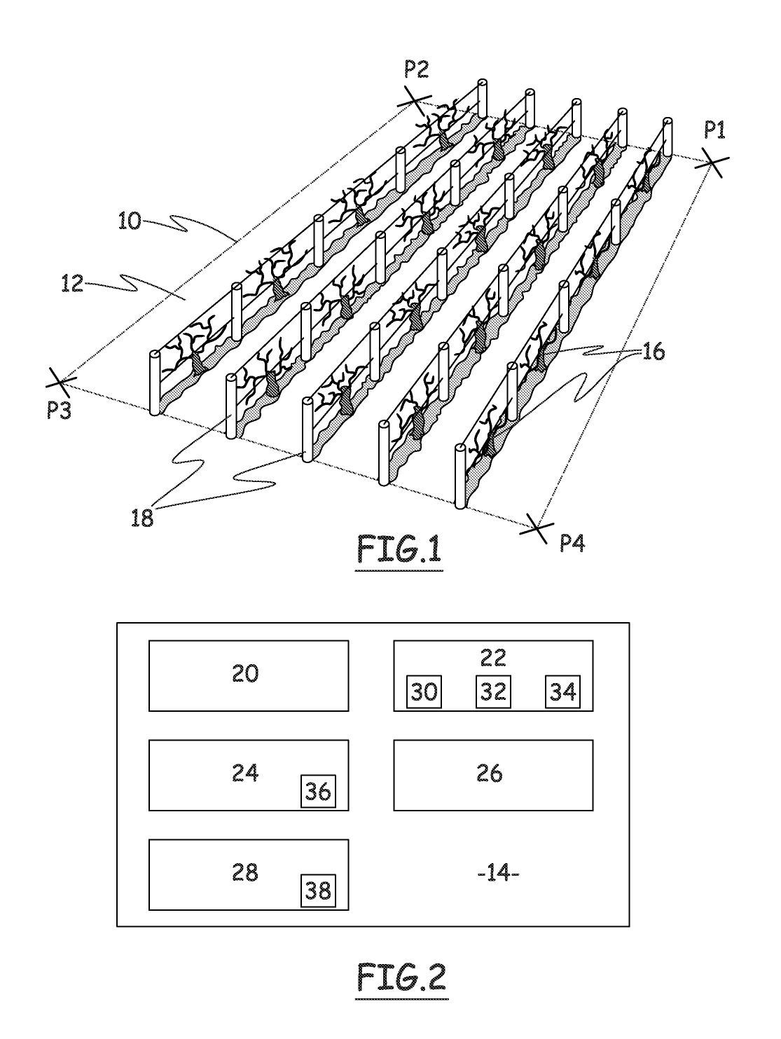

FIG. 1 illustrates the definition of a limited working perimeter of the process for tending an agricultural estate according to the invention,

FIG. 2 is a view in the form of a diagram of an autonomous working device that allows the execution of the process for tending an agricultural estate according to the invention.

The process according to the invention has as its object to facilitate the tending of an agricultural estate, in particular a wine-growing or arboricultural estate, by allowing an autonomous execution of a tending operation on a limited working perimeter 10.

By limited working perimeter 10, the invention means a virtual surface 12, defined inside the surface of the agricultural estate or corresponding essentially to said surface of said agricultural estate.

So as to allow an autonomous execution of the tending operation, an autonomous working device 14 is associated with said tending process.

The virtual surface 12 of the limited working perimeter 10 is defined by virtual limits that the autonomous working device 14 is able to recognize. According to the invention, the process for tending an agricultural estate consists in:
Defining at least one limited working perimeter 10,
Carrying out a tending operation within said limited working perimeter 10 with at least one working device 14 that is autonomous and able to recognize the limits of said limited working perimeter 10,
Allowing the autonomous working device 14 to move randomly within the limited working perimeter 10.

By random movement, the invention means that the autonomous working device makes a path at random through the vine rows or tree rows, independently of their alignment and their orientation in the working perimeter.

In the manner of a herd within an enclosure, several autonomous working devices 14 can simultaneously move and carry out a tending operation within the same limited working perimeter 10 so as to reduce the working time and the surface area left over when the tending operation is stopped.

So as to define the virtual surface 12 that corresponds to the limited working perimeter 10, the process provides for selecting at least three geographic points P that belong to said agricultural estate.

FIG. 1 shows an example in which the tending process according to the invention uses four geographic points (P1, P2, P3, P4) for defining the virtual surface 12 of the working perimeter 10.

In a more general manner, the tending process can use n different geographic points (P1, P2, . . . , Pn−1, Pn) for defining said virtual surface 12 that therefore corresponds to a polygon with n sides.

Of course, the invention also covers any other geometric means with a definition of a virtual surface 12, such as, for example, the use of a center and the diameter of a circle.

The order of geographic points (P1, P2, . . . , Pn−1, Pn) defines the different sides of said polygon: the first side that connects the pair of points (P1, P2), the second side that connects the pair of points (P2, P3), . . . , and the last side that connects the pair of points (Pn, P1) so as to obtain a closed virtual surface 12, and therefore an entirely delimited working perimeter 10.

The geolocalization of the points (P1, P2, . . . , Pn−1, Pn) can be performed using a satellite positioning system, such as GPS or the more precise DGPS with a local antenna, or using a radiofrequency localization employing a telecommunication network, such as the GSM, Wi-Fi or Bluetooth network, or else using a localization by radiofrequency with active RFID tags.

The process according to the invention is most particularly designed to facilitate the tending of the grass ground cover in an agricultural estate, in particular a wine-growing or arboricultural estate.

The tending operation that is carried out with the process according to the invention is therefore grass mowing.

This grass mowing, carried out autonomously by said autonomous working device 14, can therefore be carried out more uniformly than with the devices and the methods of the prior art, and a grass height that is selected by the farmer based on purely agronomical parameters can be retained with smaller labor costs.

In addition, so as to influence the presence and the development of the different plant types based on exposure and characteristics of the terrain on which the agricultural estate is located, the tending process according to the invention provides for varying the cutting height.

Thus, by combining a cutting height with different working perimeters 10 or with different limited zones of a working perimeter 10, the farmer can monitor the effects of the grass ground cover on the biotope. The agronomical advantage of the tending process according to the invention compared to a lawn-mowing process that strives for a constant cutting height is noted here.

On the one hand, the process according to the invention can provide for carrying out the mowing on only one fraction of the working perimeter 10 or only close to at least one limited zone, whereby a limited zone is identified by at least one geographic point, with a cutting height that is provided for each limited zone.

Or, on the other hand, the process according to the invention can provide for carrying out the mowing of the working perimeter 10 except close to at least one limited zone, whereby a limited zone is identified by at least one geographic point in the working perimeter 10.

More generally, the process according to the invention provides for carrying out a tending operation of an agricultural estate with execution parameters that are suitable to a fraction of the working perimeter 10 and/or only close to at least one limited zone.

So as to make it possible for the autonomous working device 14 to avoid the vine bases 16, or the trees, and the trellis posts 18, the tending process comprises a permanent detection of obstacles during the random movement of said device 14 within the limited working perimeter 10.

Said permanent detection of obstacles can consist of a detection of proximity or contact with an obstacle, and it can be used for selecting the best redirection possible of the trajectory of the autonomous working device 14 in the face of an obstacle.

In addition, so as to facilitate said random movement of the autonomous working device 14 between the vine bases 16, the trees and the trellis posts 18, the mowing that is done is cutting over a small width in such a way as to limit the space requirement and therefore to increase the agility of the autonomous working device 14.

An autonomous working device 14 for the execution of the process for tending an agricultural estate, in particular a vine-growing or arboricultural estate, and more particularly designed for tending the grass ground cover, is shown in diagram form in FIG. 2.

According to the invention, an autonomous device 14 comprises supply means 20, movement means 22, cutting means 24, means for detecting obstacles 26, and means 28 for navigating within the limited working perimeter 10.

Advantageously, so as to be able to change the cutting height, an autonomous device 14 also comprises automated means for variation of the height of the cutting means 24.

The supply means 20 provide the energy that is necessary for the movement means 22, the cutting means 24, the means 26 for detecting obstacles, as well as navigation means 28.

In contrast, these supply means 20 have an autonomy that is adapted to the surface of the limited working perimeter 10 so as to prevent or to limit the stops in the course of the tending operation.

In a preferred embodiment, these supply means 20 provide electrical power and assume the form of a fuel cell, in particular a hydrogen cell.

Still in this preferred embodiment, the movement means 22 comprise at least one electric motor 30 and at least one movement element 32, such as a wheel, driven by said electric motor. Said movement means 22 also comprise at least one directional movement element 34 in such a way as to be able to modify the direction of movement of said autonomous device 14 in the face of an obstacle.

Advantageously, the electric motor 30 is limited in power so as to promote the autonomy of the power plant of the autonomous working device 14.

The cutting means 24, in particular a blade, have a small width, of several tens of centimeters to provide a connection, and they comprise speed control means 36 according to the grass height or the speed of movement of the autonomous device 14.

The small cutting width and the speed control of the cutting means 24 make it possible to limit the electrical power that is consumed and therefore to promote the autonomy of movement and of work of the autonomous device 14.

The means 26 for detection of the autonomous device comprise at least one detector of proximity or contact, in particular by impact, of an obstacle.

Finally, the navigation means 28 perform a localization of said autonomous device 14 in real time within the limited working perimeter 10 using a satellite positioning system, such as GPS, or DGPS, or using a localization by radiofrequency employing a telecommunication network, such as the GSM, Wi-Fi or Bluetooth network, or active RFID tags.

These navigation means 28 comprise recording means 38 in such a way as to be able to record the coordinates of the geographic points P that delimit the working perimeter 10 as well as the coordinates of different obstacles, such as rocks, of direction changing points or reference points selected by training during the course of a tending operation.

Advantageously, this training can be used, during the course of at least one tending operation, to take inventory of the bases of the vines, or the trees, and to record their coordinates so as to identify the bases, or the trees, that are missing during the execution of a subsequent tending operation.

In an improved embodiment, an autonomous device 14 comprises means for capturing images and means for transmission of said images so as to allow the vintner to observe the vineyard remotely at different points of the working perimeter 10, in particular so as to check for the appearance of mildew, powdery mildew, or other cryptogamic diseases.

In addition, with the vintner knowing the zones of his estate at which the first traces of disease appear, the means for capturing images can be programmed to record images only at certain limited zones of the working perimeter 10, whereby a limited zone is identified by the coordinates of at least one geographic point.

For the same purpose of monitoring an agricultural estate, an autonomous device 14 can comprise olfactometry means so as to analyze the odors released by the vine, or the trees, and its environment. Like the image capturing means, the olfactometry means can be programmed for recording odors only at certain limited zones of the working perimeter 10, whereby a limited zone is identified by the coordinates of at least one geographic point.

Of course, the invention also covers the application of this tending process and of the autonomous working device 14 to any other tending operation of an agricultural estate, whereby the cutting means 24 of the autonomous device can be replaced by other suitable tending means.

Likewise, it is possible on the same agricultural estate, within the same working perimeter 10, to provide several autonomous devices.

These autonomous devices can perform the same work or additional services, for example different cutting heights, with a tandem movement.

1. Process for tending an agricultural estate, in particular a wine-growing or arboricultural estate, characterized in that it consists in:
Defining at least one limited working perimeter (10) corresponding to a virtual surface (12) that is defined by at least three geographic points P, and
Carrying out a tending operation within said limited working perimeter (10) with at least one working device (14) that is autonomous and able to recognize the limits of said limited working perimeter (10),
Allowing the autonomous working device (14) to move randomly within the limited working perimeter (10).

2. Process for tending an agricultural estate, in particular a wine-growing or arboricultural estate, according to claim 1, wherein it provides for carrying out a tending operation with execution parameters that are suitable to a fraction of the working perimeter (10).

3. Process for tending an agricultural estate, in particular a wine-growing or arboricultural estate, according to claim 2, wherein it provides for carrying out a tending operation close to at least one limited zone that is identified by at least one geographic point in the working perimeter (10).

4. Process for tending an agricultural estate, in particular a wine-growing or arboricultural estate, according to claim 1, wherein the limited working perimeter (10) corresponds to a virtual surface (12) that is defined by geolocalization of n geographic points (P1, P2, . . . , Pn−1, Pn) belonging to the wine-growing estate, whereby the order of geographic points (P1, P2, . . . , Pn−1, Pn) essentially defines a polygon with n sides: whereby the first side connects the pair of points (P1, P2), the second side connects the pair of points (P2, P3), . . . , and the last side connects the pair of points (Pn, P1) so as to obtain a closed virtual surface (12).

5. Process for tending an agricultural estate, in particular a wine-growing or arboricultural estate, according to claim 1, wherein the tending operation that is carried out is grass mowing.

6. Process for tending an agricultural estate, in particular a wine-growing or arboricultural estate, according to claim 5, wherein the mowing that is done is cutting over a small width.

7. Process for tending an agricultural estate, in particular a wine-growing or arboricultural estate, according to claim 1, wherein it comprises a permanent detection of obstacles during the random movement of the autonomous working device (14) within the limited working perimeter (10) so as to avoid the vine bases (16), the trees, and the trellis posts (18).

8. Autonomous device (14) for the execution of the process for tending an agricultural estate, in particular a wine-growing or arboricultural estate, according to claim 1, wherein it comprises supply means (20), movement means (22), cutting means (24), means (26) for detecting obstacles, and means (28) for navigating within the limited working perimeter (10).

9. Autonomous device (14) according to claim 8, wherein the navigating means (28) implement a localization of said autonomous device (14) in real time within the limited working perimeter (10) using a satellite positioning system, such as GPS or DGPS, or using a localization by radiofrequency employing a telecommunication network, such as the GSM, Wi-Fi or Bluetooth network, or active RFID tags.

10. Autonomous device (14) according to claim 8, wherein the navigating means (28) comprise recording means (38) so as to be able to record the coordinates of geographic points P that delimit the limited working perimeter (10), as well as the coordinates of different obstacles encountered during the course of the tending operation.

11. Autonomous device (14) according to claim 7, wherein it comprises automated means for variation of the height of the cutting means (24).

12. Process for tending an agricultural estate, in particular a wine-growing or arboricultural estate, according to claim 2, wherein the limited working perimeter (10) corresponds to a virtual surface (12) that is defined by geolocalization of n geographic points (P1, P2, . . . , Pn−1, Pn) belonging to the wine-growing estate, whereby the order of geographic points (P1, P2, . . . , Pn−1, Pn) essentially defines a polygon with n sides: whereby the first side connects the pair of points (P1, P2), the second side connects the pair of points (P2, P3), . . . , and the last side connects the pair of points (Pn, P1) so as to obtain a closed virtual surface (12).

13. Process for tending an agricultural estate, in particular a wine-growing or arboricultural estate, according to claim 3, wherein the limited working perimeter (10) corresponds to a virtual surface (12) that is defined by geolocalization of n geographic points (P1, P2, . . . , Pn−1, Pn) belonging to the wine-growing estate, whereby the order of geographic points (P1, P2, . . . , Pn−1, Pn) essentially defines a polygon with n sides: whereby the first side connects the pair of points (P1, P2), the second side connects the pair of points (P2, P3), . . . , and the last side connects the pair of points (Pn, P1) so as to obtain a closed virtual surface (12).

14. Process for tending an agricultural estate, in particular a wine-growing or arboricultural estate, according to claim 2, wherein the tending operation that is carried out is grass mowing.

15. Process for tending an agricultural estate, in particular a wine-growing or arboricultural estate, according to claim 3, wherein the tending operation that is carried out is grass mowing.

16. Process for tending an agricultural estate, in particular a wine-growing or arboricultural estate, according to claim 4, wherein the tending operation that is carried out is grass mowing.

17. Process for tending an agricultural estate, in particular a wine-growing or arboricultural estate, according to claim 2, wherein it comprises a permanent detection of obstacles during the random movement of the autonomous working device (14) within the limited working perimeter (10) so as to avoid the vine bases (16), the trees, and the trellis posts (18).

18. Process for tending an agricultural estate, in particular a wine-growing or arboricultural estate, according to claim 3, wherein it comprises a permanent detection of obstacles during the random movement of the autonomous working device (14) within the limited working perimeter (10) so as to avoid the vine bases (16), the trees, and the trellis posts (18).

19. Process for tending an agricultural estate, in particular a wine-growing or arboricultural estate, according to claim 4, wherein it comprises a permanent detection of obstacles during the random movement of the autonomous working device (14) within the limited working perimeter (10) so as to avoid the vine bases (16), the trees, and the trellis posts (18).

20. Process for tending an agricultural estate, in particular a wine-growing or arboricultural estate, according to claim 5, wherein it comprises a permanent detection of obstacles during the random movement of the autonomous working device (14) within the limited working perimeter (10) so as to avoid the vine bases (16), the trees, and the trellis posts (18).
